(19) United States
(12) Patent Application Publication
(10) Pub. No.: US 2021/0152278 A1
(43) Pub. Date: May 20, 2021

(54) INTERACTION BASED THERMAL MITIGATION

(71) Applicant: T-Mobile USA, Inc., Bellevue, WA (US)

(72) Inventors: Wafik Abdel Shahid, Kenmore, WA (US); Ming Shan Kwok, Seattle, WA (US)

(73) Assignee: T-Mobile USA, Inc., Bellevue, WA (US)

(21) Appl. No.: 16/685,650

(22) Filed: Nov. 15, 2019

(51) Int. Cl. H04L 1/00; G01K 3/00

(52) U.S. Cl. CPC H04L 1/0011; G01K 3/005; H04L 1/0015

(57) ABSTRACT

Systems and methods directed to the modification of a coding scheme associated with a data connection between a user device and a radio access network (RAN) are discussed herein. The coding scheme can be modified based at least on a determination that a threshold is satisfied by the user device or the data connection. The user device can include one or more device metrics and can determine one or more connection metrics associated with the data connection that are reported to the RAN by a user device report. Based on the user device report, the RAN can identify the threshold satisfied by the user device or the data connection and determine a coding scheme modification that causes the user device or the data connection to no longer satisfy the threshold.

### BACKGROUND

A user device can connect to a network and receive millimeter wave (mmW) signals that transmit data to the user device. The use of such mmW technology can enable the network to transmit a high volume of data to the user device and cause the user device to consume excessive current as the received data is processed by the user device. Ongoing high-volume data transmission can cause a temperature associated with the user device to reach temperatures that result in a negative user experience, place excessive strain on components of the user device, and overheat the device. In response, the user device can detect a high internal temperature and enforce thermal mitigation that causes services associated with the network and the user device to be terminated or suspended.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 depicts a network including both 4G and 5G infrastructure connecting a user device to a network core, wherein a data connection between the 5G infrastructure and the user device is manipulated based on one or more user device reports and by one or more RAN commands sent by a 5G RAN.

FIG. 2 illustrates an example process for determining that a threshold is satisfied by a user device and, in response, modifying a coding scheme associated with one or more data transmissions to regulate the user device.

FIG. 3 illustrates an example process for adapting a data connection while preventing a user device from satisfying a threshold and increasing utilization of the data connection by the user device.

FIG. 4 illustrates an example process for modifying a data connection associated with a user device after a first modification has not remedied a satisfied threshold or an under-utilized data connection.

FIG. 5 illustrates an example a timing diagram for modifying a data connection between a user device and a radio access network of the present disclosure.

FIG. 6 is a block diagram of a radio access network capable of implementing the techniques discussed herein.

### DETAILED DESCRIPTION

This disclosure describes systems, devices, and techniques for managing a thermal load of a user device. In some examples, the thermal load can be caused by and/or can be associated with receiving and processing data from a network. By managing the thermal load of the user device, the network can prevent services from being shut down, terminated, or suspended. Additionally, thermal load management can prolong operation of the user device, protect internal components of the user device from damage, and prevent elevated user device temperatures from resulting in a negative user experience. Further, preventing suspension and termination of network services can similarly maintain a positive user experience. The described systems, devices, and techniques can monitor data transmissions between the user device and a radio access network (RAN) of any network infrastructure including, but not limited to, third generation (3G), fourth generation (4G), fifth generation (5G), and future generations of networks. In particular, the described systems, devices, and techniques can monitor and maintain millimeter wave (mmW) data transmissions between a 5G RAN and the user device.

In some embodiments, the systems, devices, and techniques described herein improve the efficiency and functionality for a 5G network by enabling a RAN to receive user device reports, determine a device state associated with the user device, and determine a coding scheme associated with a data connection of the user device. In at least one embodiment, the device state can comprise one or more device metrics, associated with the user device, that are related to a threshold. Accordingly, the user device and/or the RAN can determine whether the one or more device metrics satisfy the threshold. In response to the threshold being satisfied, the RAN can determine a modified coding scheme and/or an alternative coding scheme to be applied to the data connection between the user device and the network. In at least one additional embodiment, the device state can include a data connection status, associated with the user device, that indicates that the data connection can support increased data transmission or that the data connection is being fully utilized by the user device and the network. In response to the data connection being able to support increased data transmission, the RAN can determine a modified coding scheme to be applied to the data connection and monitor the device status. Accordingly, the RAN can enable the user device to utilize the full capabilities of the network supported by the data connection, while enforcing operating limits associated with the user device.

In some embodiments, the user device can periodically generate and transmit a user device report to the network. In at least one embodiment, the user device report can be configured to report one or more indicators associated with the user device. The user device report can comprise a channel quality indicator (CQI), a pre-coding matrix indicator (PMI), a rank indicator (RI), or other indicators that are regularly transmitted from the user device to the network. Additionally, the user device report can be modified to include the device status in addition to the one or more indicators of the user device report. In some additional embodiments, the user device can periodically generate and transmit an independent report comprised of the device status and/or one or more device metrics. In some additional embodiments, the one or more device metrics can comprise a current temperature, a current power consumption, and/or one or more current operating values (e.g., processor speed) of the user device to the network.

In some embodiments, the user device can aperiodically generate and transmit a user device report to the network. In particular, the user device can determine that the current status of the user device is to be reported to the network. In at least one embodiment, the network can transmit a request to the user device and cause the user device to transmit the user device report. Additionally, the request can specify the one or more device metrics associated with the user device (e.g., the current temperature, the current power consumption, and/or one or more current operating values) to be included in the user device report. Alternatively, the request can specify a device metric, associated with the user device, to be included in a device metric report. In at least one additional embodiment, the user device can determine that the user device report is to be generated for the network based on a threshold associated with the one or more device metrics. For example, the network can determine and transmit the threshold to be utilized by the user device to identify when the user device report is to be generated. Alternatively, the user device can comprise the threshold and one or more instructions for identifying when the user device report is to be generated based on the threshold.

In some embodiments, the RAN can receive the user device report from the user device. As noted above, the user device report can be received on a periodic or aperiodic basis (e.g., regular or irregular intervals) from the user device. Additionally, the user device report can be a modified report that has been altered by the user device to include an indication associated with the one or more device metrics. Further, the user device report can be a generated report. The generated report can be configured, by the user device, to specifically report the one or more device metrics to the RAN.

In some additional embodiments, the RAN can determine whether the one or more device metrics satisfy the threshold. For example, the RAN can receive a device metric such as a current temperature, a current power consumption, or a current processor speed. Additionally, the threshold can indicate that the user device should not experience temperatures over the threshold (e.g., user device temperature should not exceed 40° C.). Further, the RAN can determine whether the user device satisfies the threshold based on the current temperature provided by the user device report or calculate the current temperature based on one or more other device metrics (e.g. power consumption, processor speed, etc.). From the calculated device temperature, the RAN can determine whether the user device satisfies the threshold. It should be noted that the above described example is meant to provide a reference for how the threshold can be satisfied by the one or more device metrics and should not be read as limiting this disclosure. In at least one embodiment, the RAN can determine whether a plurality of thresholds is satisfied by the one or more device metrics. In at least one additional embodiment, the RAN can determine a first device metric from one or more second device metrics similar to the determination of the current temperature based on the current power consumption and/or the current processor speed.

In some embodiments, the RAN can receive the user device report from the user device based on a determination made by the user device. As noted above, the threshold can be provided to the user device by the network or the user device can include the threshold. Accordingly, the user device can determine that the user device report should be generated and send to the RAN in response to the threshold being satisfied by the one or more device metrics. Additionally, the user device can determine whether the threshold is satisfied by the threshold and modify the user device report to include the one or more device metrics. Similarly, the user device can modify the user device report to include an indication that the threshold is satisfied by the one or more device metrics.

In some embodiments, the RAN can request the user device report from the user device or receive the user device report from the user device based on a determination that an amount of data has been transmitted via the data connection and/or received by the user device. In particular, the RAN or the user device can monitor the transmission of data via the data connection and monitor the amount of data that has been transmitted and/or received. Additionally, once the amount of data transmitted/received exceeds a threshold amount of data, the RAN can request, or the user device can send, the user device report. In at least one embodiment, the RAN or the user device can monitor the amount of data transmitted/received over a time period. Further, the RAN or the user device can determine whether the amount of data transmitted/received over the period of time exceeds the data threshold associated with the time period. In at least one additional embodiment, the user device report can be modified based on the one or more device metrics associated with the amount of data or the time period associated with the user device report. Additionally, the user device report can be modified to report the one or more device metrics, of the amount of data or during the time period, that satisfy an additional threshold.

In some embodiments, the RAN can request the user device report from the user device. Similar to the user device, the RAN can request the user device report on a periodic or aperiodic basis. In particular, the RAN can request the user device report in response to an indication of the device state associated with the user device or the current data connection associated with the user device. In at least one embodiment, the RAN can request the user device report in response to determining that the current data connection is being under-utilized (i.e., the current data connection is transmitted data to and from the user device at a bandwidth below what the network and the current data connection can support). In response, the RAN can determine whether a coding scheme that increases utilization of the current data connection should be implemented for the user device and the data connection. For example, the RAN can request the user device report to receive and/or determine the one or more device metrics. From the one or more device metrics, the RAN can determine whether the threshold is satisfied by the user device (e.g., the user device exceeds a temperature threshold). Additionally, if the user device satisfies the threshold, the RAN can determine that the coding scheme configured to increase utilization of the data connection should not be applied to the user device. Further, the RAN can determine, based on the user device satisfying the threshold, that an additional coding scheme is to be determined to reduce the one or more device metrics below the threshold. Alternatively, the RAN can determine that the user device does not satisfy the threshold and apply the coding scheme to the user device and the data connection.

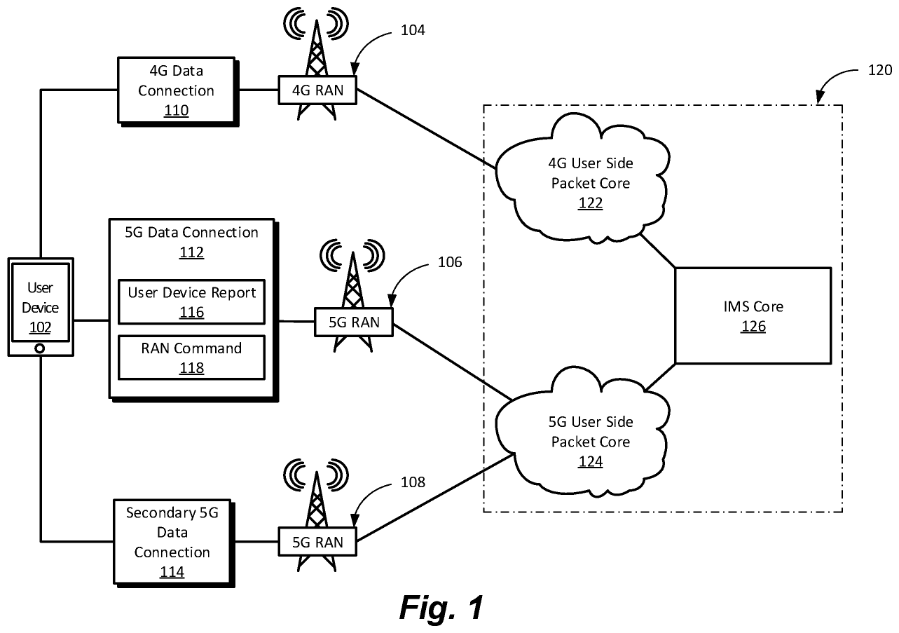

FIG. 1 is a diagram illustrating a network according to some embodiments. The network can comprise network infrastructure associated with both 4G and 5G networks. While this disclosure primarily discusses scenarios where the network is comprised of 4G and 5G network infrastructures, the core methodology is applicable to other network infrastructures and the network is not limited to the illustrated embodiments. Additionally, the network can utilize alternative network infrastructures associated with 3G networks, future generations of telecommunication networks, wireless local area networks, local area networks, wide area networks, digital subscriber line networks, and other types IP connectivity access networks (IP-CAN). In particular, a user device 102 can connect with the network via a 4G RAN 104, a 5G RAN 106, and an additional 5G RAN 108 through a 4G data connection 110, a 5G data connection 112, and a secondary 5G data connection 114. In some embodiments of the claims, the 5G data connection 112 can transmit a user device report 116 and a RAN command 118 between the user device 102 and the 5G RAN 106. Additionally, each of the data connections can further connect the user device 102 with a network core 120 of the network. Further, the network core 120 can comprise a 4G user side packet core 122, a 5G user side packet core 124, and an IMS core 126. In some additional embodiments, the 5G user side packet core 124 can be omitted and the 5G data connection 112 can be associated with the 4G user side packet core 122.

In some embodiments of FIG. 1, the user device 102 can be any suitable computing device configured to communicate over a wireless and/or wireline network, including, without limitation, a mobile phone (e.g., a smart phone), a tablet computer, a laptop computer, a portable digital assistant (PDA), a wearable computer (e.g., electronic/smart glasses, a smart watch, fitness trackers, etc.), a network digital camera, a global positioning system (GPS) device, and/or other similar mobile devices. Although this description predominantly describes the user device 102 as being “mobile” or “wireless,” (e.g., configured to be carried and moved around), it is to be appreciated that the user device 102 may represent various types of communication devices that are generally stationary as well, such as televisions, desktop computers, game consoles, set top boxes, and the like. In this sense, the terms “communication device,” “wireless device,” “wireline device,” “mobile device,” “computing device,” “terminal,” “user equipment,” and “user device” may be used interchangeably to describe a user device capable of performing or participating in the techniques described herein.

In some additional embodiments, the user device 102 can comprise one or more processors that are configured to receive and process data that is received via the 4G data connection 110, the 5G data connection 112, and/or the secondary 5G data connection 114. Accordingly, the user device 102 can monitor and record one or more device metrics associated with internal components of the user device. As noted above the one or more device metrics can include a device temperature, a device power consumption, one or more processor speeds, one or more temperatures associated with internal components of the user device, and other metrics associated with the functionality of the user device. In at least one embodiment, the user device 102 can include a capability to maintain multiple simultaneous data connections with different network access technologies. For example, the user device 102 can maintain and transmit data via the 4G data connection 110 and the 5G data connection 112. In at least one additional embodiment, the user device is configured to transmit data over data connections that utilize a multiple input multiple output (MIMO) framework for data transmissions. For example, the 5G data connection 112 and the secondary 5G data connection 114 can be configured as individual data connections of the MIMO framework for data transmissions between the user device 102 and the network core 120.

In some embodiments of FIG. 1, the 5G data connection 112 can be configured to receive data from the user device 102 via an uplink data connection and transmit data to the user device 102 via a downlink data connection. Additionally, the 5G data connection 112 can specify a coding scheme that is used to transmit data via the uplink and the downlink connections. In at least one embodiment, the coding scheme is a modulation and coding scheme (MCS) that is associated with the 5G data connection 112. Additionally, the MCS can be associated with a time transmission interval (TTI) and a transport block size (TB size) that define the amount of data that is transmitted via the 5G data connection 112 over a period of time. Generally, The TTI indicates a duration that is associated with the plurality of slots (i.e., data values associated with a period of time) that comprise a network frame (i.e., a network packet that comprises multiple slots). For example, the TTI can indicate that a network frame is comprised of 10 subframes (i.e., slots) having a duration of 1 millisecond to form a 10-millisecond duration network frame. However, the TTI can indicate that the slot duration is any appropriate duration for transmitting data between the 5G RAN 106 and the user device 102 and the network frame can comprise any number of slots. Additionally, the slot duration indicated by the TTI can vary between data connections that are associated with the user device 102. Similarly, the TB size indicates the amount of data that is transmitted in association with each slot of the network frame. Accordingly, changing the MCS can alter the amount of data that is transmitted via the 5G data connection 112 by the 5G RAN 106 or other data connections associated with the user device 102. Further, the changes made to the MCS can adjust the TB size associated with the 5G data connection 112 and the other data connections.

In some embodiments of FIG. 1, and as noted above, the network core 120 can comprise the 4G user side packet core 122, the 5G user side packet core 124, and the IMS core 126. Individual network nodes comprising the network core 120, the 4G user side packet core 122, the 5G user side packet core 124, and the IMS core 126 can be virtualized nodes, physical nodes, or any combination of the two. In at least one embodiment, the 4G user side packet core 122 can include a Mobile Management Entity (MME), a Packet Gateway (PGW), a Session Gateway (SGW), and other databases. In at least one additional embodiment, the 5G user side packet core 124 can include an Access Management Function (AMF), a Session Management Function (SMF), a User Plane Function (UPF), a Network Resource Function (NRF), and other databases. In at least one further embodiment, the IMS core 126 can include Proxy Call Session Control Functions, Interrogating Call Session Control Functions (I-CSCFs), Service Call Session Control Functions (S-CSCFs), and other network nodes. The term user-side packet core is not intended to limit the present disclosure to packet switched connections. Instead, the technology discussed herein can be implemented on alternative technologies including at least a circuit-switched network. Similarly, the term IMS core is not intended to limit the present disclosure as other network architectures or frameworks may support implementation of the systems and methods discussed herein.

In some embodiments of FIG. 1, and as noted above, the user device report 116 can be transmitted via the 5G data connection 112 to the 5G RAN 106 on a periodic or aperiodic basis. Additionally, the user device report 116 can comprise a device temperature, a device power consumption, a processor speed, and other device metrics. The one or more device metrics can be included in a generated user device report or a modified user device report. For example, the user device 102 can modify a Channel Quality Indicator report, a Pre-coding Matrix Indicator report, a Rank Indicator report, Channel Status Information report, or other report that is transmitted from the user device 102 to the 5G RAN 106.

In some embodiments of FIG. 1, the RAN command 118 can provide instructions to the user device 102 that alter the 5G data connection 112. In at least one embodiment, the RAN command 118 can indicate a coding scheme that will be utilized by the 5G data connection in response to the user device report 116. In particular, the RAN command 118 can instruct the user device 102 to lower the modulation and/or the MCS associated with the 5G data connection 112. Additionally, the RAN command 118 can instruct the user device 102 to reduce a receive window or a TTI associated with the 5G data connection 112. In at least one additional embodiment, the RAN command 118 can cause the user device 102 to lower its power consumption. In particular, the RAN command 118 can be a Transmit Power Control (TPC) command that controls Physical Uplink Shared Channel (PUSCH) transmit power that can be modified to reduce the device power consumption of the user device 102.

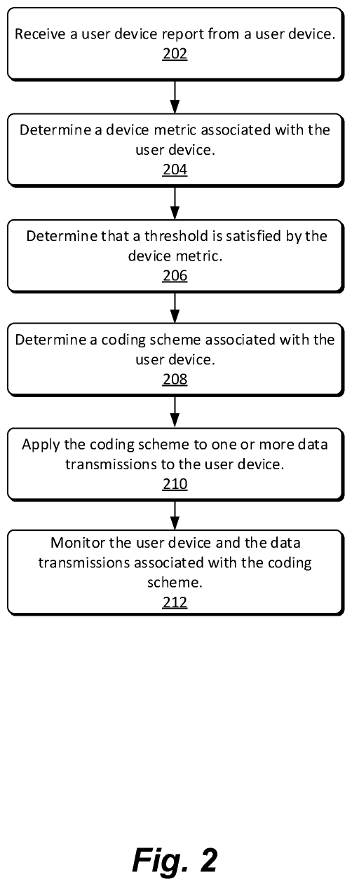

FIGS. 2-4 illustrate example processes in accordance with embodiments of the disclosure. These processes are illustrated as logical flow graphs, each operation of which represents a sequence of operations that can be implemented in hardware, software, or a combination thereof In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel (or omitted) to implement the processes.

FIG. 2 illustrates an example process for determining that a threshold is satisfied by a user device and, in response, modifying a coding scheme associated with one or more data transmissions to regulate the user device. In some embodiments, the method depicted by FIG. 2 can be implemented by the 5G RAN 106 to modify the 5G data connection 112. Additionally, the modifications can be applied at the 5G RAN 106 and/or at the user device 102 according to the RAN command 118. Further, the modifications to the 5G data connection 112 can be determined based at least on the user device report 116.

At block 202, a RAN can receive a user device report from a user device. For example, the user device 102 can transmit the user device report 116 to the 5G RAN 106 via the 5G data connection 112. As noted above, the user device report can include one or more device metrics comprising a device temperature, a device power consumption, one or more processor speeds, and/or one or more other device metrics. In some embodiments, the user device report can be one of a plurality of user device reports. Additionally, the RAN can monitor a device status associated with the user device by tracking the one or more device metrics across the plurality of user device reports. In some additional embodiments, the user device report can comprise an independent report of the one or more device metrics to the RAN.

Additionally, at block 202, the user device can send the user device report on a periodic or aperiodic basis. In some embodiments, the RAN can cause the user device report to include the one or more device modifiers. For example, the RAN can transmit a request for the one or more user device metrics and cause the user device to transmit the one or more device metrics to the RAN. Additionally, the user device to modify the user device report to include the one or more device metrics or generate an independent user device report that includes the one or more device metrics. Alternatively, the user device can be configured to provide the one or more user device metrics to the RAN via a modified user device report or generate and send the independent user device report that comprises the one or more device metrics.

At block 204, the RAN can determine a device metric associated with the user device. In some embodiments, the user device report can simply indicate the device metric for the RAN. In some additional embodiments, the user device report can calculate the device metric based on the one or more device metrics included by the user device report. For example, the RAN can determine a temperature associated with the user device based on a processor speed and/or the device power consumption of the user device. Similarly, the RAN can determine a future temperature that the user device can reach based on the processor speed and/or the device power consumption.

At block 206, the RAN can determine that a threshold is satisfied by the device metric. In some embodiments, the threshold can represent a temperature, processor speed, power consumption, or other device metric that the RAN is configured to avoid the user device from satisfying/exceeding. In some additional embodiments, the RAN can comprise one or more thresholds, wherein each of the one or more thresholds are associated with additional remedies that the RAN can utilize to reduce the one or more device metrics below the threshold. In some further embodiments, the threshold or the one or more thresholds can be configured based on the user device, the RAN, the network, a database associated with the RAN, and/or other sources of user device limitations.

At block 208, the RAN can determine a coding scheme associated with the user device. In particular, the data connection between the RAN and the user device utilizes the coding scheme to transmit data between the network and the user device. Additionally, the coding scheme determines a timing, an amount, and a rate associated with the transmission of user device data that are caused by one or more operating parameters of the coding scheme. In some embodiments, the timing for sending data can be associated with a TTI, a network frame configuration, a slot configuration, and/or other frameworks for timing the transmission of the user device data. In some additional embodiments, the amount is associated with a TB size that defines the amount of user device data transmitted to the user device via the data connection. In some further embodiments, the coding scheme is an MCS associated with the TTI and the TB size for the data connection associated with the user device. Similarly, the MCS can be associated with the rate at which the data transmission sends and receives data associated with the user device.

Additionally, at block 208, the RAN can determine a modification for the coding scheme associated with the user device. In particular, the RAN can determine whether the threshold is satisfied by the device temperature, the device power consumption, the one or more processor speeds, or the one or more other device metrics. In some embodiments, the RAN can determine that the coding scheme is to be modified to reduce the transmission of data via the data connection associated with the user device. In some additional embodiments, the RAN can report the one or more device metrics to another network node associated with the network. In response, the network node can determine that the one or more device metrics satisfy the threshold and adjust a data transmission rate associated with the RAN and the data connection.

In some embodiments, the RAN can determine whether the threshold is satisfied by the one or more device metrics and/or can determine the coding scheme to be applied to the data connection associated with the user device. In at least one embodiment, the threshold is a limit threshold associated with the one or more device metrics. Additionally, the RAN, based on determining that the limit threshold has been exceed by the one or more device metrics, can identify modifications to the coding scheme associated with the data connection of the user device that would reduce the one or more device metrics below the limit threshold. Accordingly, the modifications to the coding scheme can be configured to alter operation of the user device and cause the one or more device metrics to be reduced below the limit threshold. For example, the RAN can determine a second coding scheme associated with a lower data throughput or reduced TB size. The second coding scheme can reduce the amount of data transmitted to the user device and reduce the load on one or more processors associated with the use device, reduce the power consumption of the user device, and/or reduce the temperature of the user device.

In some additional embodiments, the RAN can report the user device report and/or the one or more device metric to a network node associated with the network. Similar to the RAN above, the network node can determine whether a threshold is satisfied by the one or more device metrics and determine the coding scheme to be applied to the data connection of the user device. In at least one embodiment, the network node can instruct the RAN to modify the coding scheme. In at least one additional embodiment, the network node can reduce the amount of data that is transmitted to the RAN and reduce the amount of data transmitted to the user device via the data connection. Accordingly, the network node that receives the user device report can be configured to address the satisfaction of the threshold by the user device through directly instructing the RAN to alter the coding scheme associated with the user device and/or by altering the data received by the RAN that is to be transmitted to the user device.

At block 210, the RAN can apply the coding scheme to the data connection and/or one or more data transmissions associated with the user device. In some embodiments, applying the coding scheme can comprise replacing a first coding scheme associated with the user device and the data connection with a second coding scheme determined by the RAN. In some additional embodiments, applying the coding scheme can comprise modifying the coding scheme to include operating parameters determined by the RAN. In at least one embodiment, the first coding scheme can a first MCS associated with a first TTI and a first TB size. Similarly, the second coding scheme can be a second MCS associated with a second TTI and a second TB size. Accordingly, the RAN can independently determine the second MCS and/or the second TB size to cause the one or more device metrics to be reduced below the threshold. The second MCS and/or the second TB size can reduce the amount of data transmitted to the user device and cause the one or more device metrics to be reduced. Alternatively, the RAN can determine the second TTI to similarly reduce the amount of data transmitted to the user device.

In some additional embodiments, the RAN can apply the coding scheme to the data connection and/or one or more data transmissions associated with the user device, wherein the coding scheme is received from the network node. In particular, the network node can, as described above, determine the second coding scheme based on the user device report and transmit the second coding scheme to the RAN. Alternatively, the network node can apply modifications to the data transmissions between the RAN and the network. For example, the network node can throttle the amount of data that is transmitted to the RAN and accordingly reduce the amount of data that is sent to the user device.

In some further embodiments, the RAN and/or the network node can determine the second coding scheme based on stored information comprising one or more potential coding schemes. In at least one embodiment, the stored information can be accessible to the RAN and/or the network node. In particular, the RAN can further comprise the stored information, access the stored information via a database, and/or request the one or more potential coding schemes from the network. For example, the stored information can comprise one or more potential MCSs, one or more TTIs, and/or one or more TB sizes. Accordingly, the RAN can select the second coding scheme from the stored information. In at least one additional embodiment, the stored information can further associate the one or more potential coding schemes with user device loads or otherwise differentiate one or more effects of implementing the one or more potential coding schemes in the data connection. Accordingly, the RAN can determine the second coding scheme from the stored information such that the second coding scheme is configured to remedy the one or more device metrics that satisfy the threshold.

At block 212, the RAN can monitor the user device, the data connection, and/or the one or more data transmissions associated with the coding scheme. As noted above, the coding scheme can be a modified coding scheme or the second coding scheme determined by the RAN. In some embodiments, the user device report received by the RAN is a periodic user device report (e.g., CQI, PMI, RI, etc.) that is repeatedly sent from the user device to the RAN after an amount of time has elapsed since a prior user device report. The periodic user device report can be modified to report the one or more device metrics to the RAN. Accordingly, the RAN can continue to monitor the one or more device metrics by receiving one or more additional user device reports, that have been modified to include the one or more device metrics, from the user device. Additionally, the periodic user device report can be a custom report generated to contain the one or more device metrics and report the one or more device metrics on a periodic basis. In some additional embodiments, the user device report received by the RAN is an aperiodic user device report. In at least one embodiment, the aperiodic user device report can be a single instance of a modified periodic user device report. In at least one additional embodiment, the aperiodic user device report can be a single report generated to contain and report the one or more device metrics. Accordingly, the RAN can request and/or the user device can generate a second aperiodic user device report comprising a second value of the one or more device metrics such that the RAN can monitor the user device. Additionally, the RAN can determine whether the threshold remains satisfied by the one or more device metrics received via the second aperiodic user device report or the one or more additional user device reports received on a periodic basis.

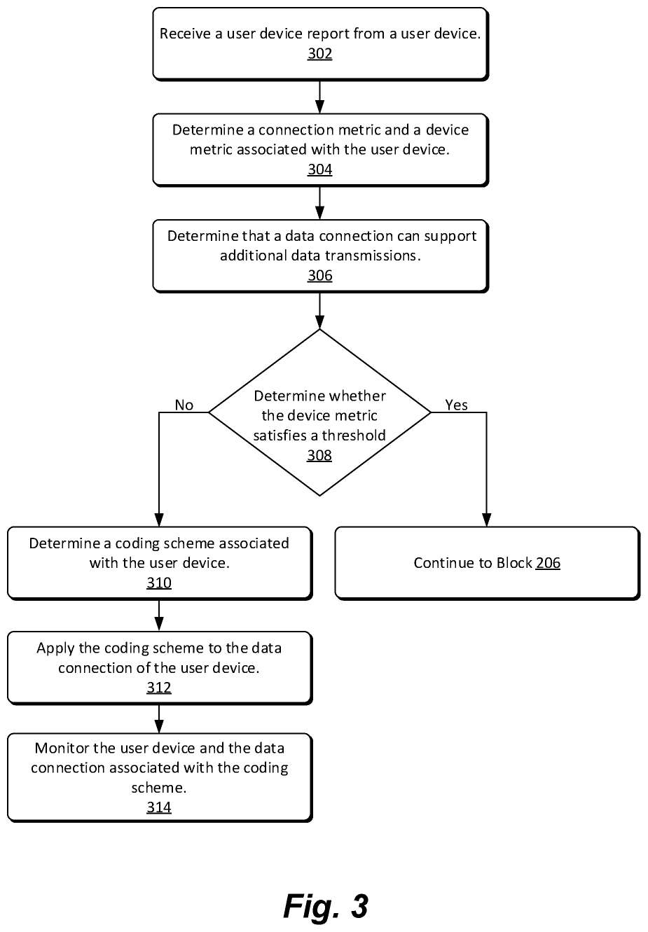

FIG. 3 illustrates an example process for adapting a data connection to a channel quality by preventing a user device from satisfying a threshold while increasing utilization of the data connection by the user device. In some embodiments, the method depicted by FIG. 3 can be implemented by the 5G RAN 106 to modify the 5G data connection 112. Additionally, the modifications can be applied at the 5G RAN 106 and/or at the user device 102 according to the RAN command 118. Further, the modifications to the 5G data connection 112 can be determined based at least on the user device report 116.

At block 302, and similar to block 202, a RAN can receive a user device report from a user device. For example, the user device 102 can transmit the user device report 116 to the 5G RAN 106 via the 5G data connection 112. As noted above, the user device report can include one or more device metrics comprising a device temperature, a device power consumption, one or more processor speeds, and/or one or more other device metrics. In some embodiments, the user device report can be one of a plurality of user device reports. Additionally, the RAN can monitor a device status associated with the user device by tracking the one or more device metrics across the plurality of user device reports. In some additional embodiments, the user device report can comprise an independent report of the one or more device metrics to the RAN.

At block 304, the RAN can determine a connection metric and/or a device metric associated with the user device. In some embodiments, the connection metric can include an indication of channel quality, an indication of connection utilization, and/or other indications of a current status of the data connection associated with the user device. Additionally, the connection metric can be determined based on the user device report received from the user device. In at least one embodiment, the connection metric can be received via a CQI report, a PMI report, or a RI report. In at least one additional embodiment, the RAN can determine the connection metric based on information included in the user device report. In some additional embodiments, the device metric can be determined in the manner described with respect to block 204. Additionally, the device metric can be one of the one or more device metrics described with respect to block 204.

At block 306, the RAN can determine that the data connection can support increased data traffic, increased data throughput, and/or increased data transmissions. In some embodiments, the RAN can determine, based on the connection metric, that the data connection is under-utilized or can support additional network service(s). In particular, the RAN can determine that the data connection is under-utilized based on a bandwidth and/or the data transmission rate associated with the data connection. Additionally, if the bandwidth and/or the data transmission rate is less than a data threshold and/or an optimal data transmission rate determined based on the connection metric, the data connection is under-utilized. Accordingly, the RAN can be configured to determine, based on the connection metric, that the data connection can be modified to provide improved network services and/or increased data transmission to the user device. For example, the RAN can determine, based on the connection metric, that the data throughput and/or the data transmission rate associated with the coding scheme (e.g., the MCS) is less than what the connection indicates, via a channel quality indicator (CQI), a pre-coding matrix indicator (PMI), or a rank indicator (RI), the data connection can provide (i.e., the optimal data transmission rate).

At block 308, the RAN can determine whether the device metric satisfies a threshold associated with the device metric. In some embodiments, the RAN can determine that the device metric satisfies an associated threshold and proceed according to the method described by FIG. 2 regardless of the connection metric. For example, the RAN can determine, as described by block 306, that the data connection can support additional bandwidth and/or additional data transmissions. However, the RAN can additionally determine that the device metric (e.g., device temperature, device power consumption, etc.) exceed the threshold. In at least one embodiment, the RAN can determine that providing the additional bandwidth and/or the additional data transmissions will negatively impact a user experience associated with the user device or increase a risk of damage for the user device. Accordingly, the RAN can determine that the additional bandwidth and/or the additional data transmissions cannot be provided to the RAN and proceed according to the techniques described with respect to FIG. 2.

In some additional embodiments, the RAN can determine that the device metric does not satisfy the associated threshold and proceed according to block 310. For example, the RAN can determine that the device metric (e.g., device temperature, device power consumption, etc.) does not exceed the threshold and that the data connection can support the additional bandwidth and/or the additional data transmissions, as described by block 306, and proceed according to the techniques described with respect to FIG. 3.

At block 310, the RAN can determine a coding scheme associated with the user device. In particular, the data connection between the RAN and the user device utilizes the coding scheme to transmit data between the network and the user device. Additionally, the coding scheme determines a timing, an amount, and a rate associated with the transmission of user device data that are caused by one or more operating parameters of the coding scheme. Further, the coding scheme can comprise information and/or values as described with respect to block 208. Similarly, the RAN and/or the network device can access stored information as described with respect to block 208.

In some embodiments, the RAN can determine a second coding scheme or a modification for the coding scheme configured to increase utilization of the data connection (i.e., cause the data transmission rate of the data connection to approach the optimal data transmission rate). In particular, the coding scheme comprising a first data transmission rate associated with a first amount of data that is transmitted by the data connection. Additionally, the RAN can determine, based on the connection metric, a second data transmission rate associated with a second amount of data that the data connection is capable of transmitting via the data connection. For example, and as noted above, the data connection can be associated with a first MCS, a first TTI, a first TB size, and/or other values associated with the coding scheme that define the first data transmission rate. Further, the RAN can identify the second coding scheme, based in part on the coding scheme, from stored information associated with the RAN and/or the network. Alternatively, the RAN can determine one or more modifications to the values associated with the coding scheme to generate the second coding scheme. Accordingly, the RAN can determine the second coding scheme to increase utilization of the data connection in comparison to the coding scheme.

In some additional embodiments, the RAN can determine the second coding scheme or the modification for the coding scheme based on the connection metric and the device metric. As discussed above, the RAN can determine, identify, or calculate the second coding scheme based on the connection metric. Additionally, the RAN can further determine the second coding scheme based on the device metric and an anticipated effect, associated with the user device, that the second coding scheme can cause. In at least one embodiment, the RAN can determine that the data transmitted to the user device via the data connection should be increased and determine the second coding scheme. Additionally, the RAN can determine the second coding scheme to prevent the device metric from satisfying a threshold one the second coding scheme is applied to the data connection. For example, the RAN can determine that the second coding scheme will not cause a device temperature to exceed a device temperature threshold. In at least one additional embodiment, the RAN can iteratively identify a potential coding scheme, determine a predicted effect of the potential coding scheme associated with the device metric, and determine whether the predicted effect indicates that application of the potential coding scheme will cause the device metric to satisfy the threshold. Accordingly, the RAN can select the second coding scheme from one or more potential coding scheme such that the second coding scheme causes increased utilization of the data connection without resulting in the device metric satisfying the threshold.

In some further embodiments, the RAN can determine the second coding scheme or the modification in a stepwise manner. In particular, the RAN can determine one or more coding scheme values (e.g., MCS, TTI, TB size, etc.) associated with the coding scheme. Additionally, the RAN can identify, via a database, information stored by the RAN, and/or information stored by the network, one or more updated coding values that are increased to a next highest value compared to the one or more coding scheme values. Accordingly, the RAN can determine the second coding scheme by replacing at least one of the one or more coding scheme values with at least one of the one or more updated coding scheme values.

At block 312, the RAN can apply the one or more modifications to the coding scheme associated with the data connection or apply the second coding scheme to the data connection. In some embodiments, this can be accomplished in a manner similar to that described with respect to block 210.

At block 314, the RAN can monitor the user device and the data connection associated with the coding scheme and/or the second coding scheme. In some embodiments, the user device can be monitored in a manner similar to that described with respect to block 212. In some additional embodiments, the RAN can monitor the connection metric and the device metric by different methods. In at least one embodiment, the RAN can receive periodic user device reports including the connection metric. Additionally, the RAN can cause the periodic user device reports to be modified to include the device metric or cause additional periodic user device reports to be generated such that the device metric is reported on a periodic basis. Alternatively, the RAN can cause the device metric to be reported via an aperiodic user device report in response to a request or a schedule associated with the RAN. In at least one additional embodiment, the RAN can implement one or more additional thresholds configured to generate or cause the RAN to receive the user device report. In particular, the one or more additional thresholds can be configured such that the RAN is informed when the device metric satisfies a limit threshold and/or when the connection metric does not satisfy a floor threshold. Accordingly, the RAN can manipulate the reporting of the connection metric and the device metric such that the user device can be monitored after the second coding scheme or the one or more modifications to the coding scheme have been applied.

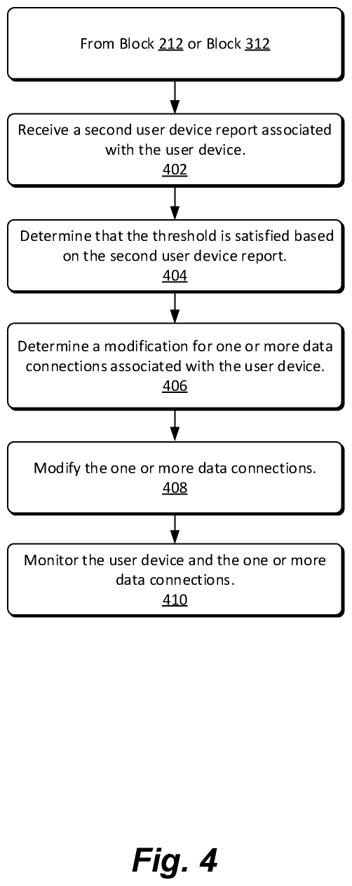

FIG. 4 illustrates an example process for modifying a data connection associated with a user device after a first modification has not remedied a satisfied threshold or an under-utilized data connection. In some embodiments, the method depicted by FIG. 4 can be implemented by the 5G RAN 106 to modify the 5G data connection 112, the secondary 5G data connection 114, and/or the 4G data connection 110. Additionally, the modifications can be applied at the 5G RAN 106 and/or at the user device 102 according to the RAN command 118. Further, the modifications to the 5G data connection 112 can be determined based at least on the user device report 116 and propagated to additional RANs. In some additional embodiments, the data connection is determined to be under-utilized based on a bandwidth and/or the data transmission rate associated with the data connection. In particular, when the bandwidth and/or the data transmission rate of the data connection is less than an optimal data transmission rate and/or below a data threshold, the data connection is said to be under-utilized.

At block 402, the RAN can receive a second user device report associated with the user device. In some embodiments, the second user device report can be received in the manner described with respect to blocks 202 and 302. In some additional embodiments, the second user device report can be received in the course of the RAN monitoring the user device as described with respect to blocks 212 and 314. In some further embodiments, the RAN can disregard one or more user device reports that are received during a grace period. In particular, the grace period can be a timeframe, configured by the RAN or the network, configured such that a second coding scheme or one or more modifications made to a coding scheme associated with the data connection to take effect before additional action by the RAN is considered. For example, the RAN can be instructed to wait for an amount of time (e.g., minutes, seconds, hours, milliseconds etc.) before determining whether a limit threshold (i.e., a temperature limit) is satisfied by a device metric (i.e., device temperature) or whether a target threshold (i.e., a data throughput) is satisfied by a connection metric.

At block 404, the RAN can determine whether one or more thresholds are satisfied by the connection metric and/or the device metric based on the second user device report. In some embodiments, the RAN can determine whether the one or more thresholds are satisfied in a manner described with respect to blocks 206 and 306. In some additional embodiments, the RAN can determine that a series of thresholds are satisfied by the threshold. For example, a first temperature threshold can indicate that the user device is not to exceed a first temperature and a second temperature threshold can indicate that the user device is not to exceed a second temperature (i.e., greater than the first temperature). Accordingly, the RAN can determine that a device temperature exceeds (i.e., satisfies) the first temperature threshold and the second temperature threshold. A similar series of thresholds can be established for virtually any user device metric by the RAN, the user device, or the network.

At block 406, the RAN can determine a modification for one or more data connections associated with the user device. In some embodiments, the modification can be associated with the data connection between the user device and the RAN. Additionally, the modification can further alter the coding scheme associated with the data connection or apply an additional coding scheme determined in a manner described with respect to blocks 208 and 310. Accordingly, the RAN can be configured to repeatedly identify a satisfied threshold associated with the data connection, determine and apply a modified coding scheme or an alternative coding scheme, monitor the user device, and iteratively alter the data connection until the threshold is no longer satisfied.

In some additional embodiments, the RAN can determine a modification associated with the one or more data connections associated with the user device. For example, the modification can be applied to the 5G data connection 112, the secondary 5G data connection 114, and/or the 4G data connection 110. In at least one embodiment, the RAN can determine that one or more layers of a plurality of layers associated with the data connection are to be closed, terminated, or suspended. In particular, the RAN can determine that the application of different coding schemes to the data connection has not and/or will not resolve the device metric and/or the connection metric satisfying the threshold. Alternatively, the RAN can determine that modifying the plurality of layers in combination with modifying the coding scheme of the data connection. Accordingly, the RAN can determine that increasing or decreasing the plurality of layers, associated with the data connect, by the one or more layers will cause the device metric and/or the connection metric to no longer satisfy the threshold. For example, the secondary 5G data connection 114 can represent a second layer associated with the user device and the 5G data connection 112. In a scenario where a device temperature exceeds a temperature threshold, the 5G RAN 106 can cause the secondary 5G data connection 114 to terminate or suspend data transmissions to and/or from the user device 102. In a second scenario where a data transmission rate is less than a supported data transmission rate associated with the user device 102, the RAN can cause the secondary 5G data connection 114 to initiate and/or resume data transmissions to and from the user device 102. Further, the RAN can determine that the plurality of layers is to be modified based on a determination that multiple thresholds of the series of thresholds are satisfied by the device metric.

In at least one additional embodiment, the modification can determine that any 5G data connection is to be terminated for the user device. In particular, the RAN can cause the user device to switch from 5G service to 4G service based on a determination that the application of different coding schemes to the data connection has not and/or will not resolve the device metric and/or the connection metric satisfying the threshold. Accordingly, the RAN can determine that 5G service is to be terminated or suspended and that data transmissions are to be sent and received via a 4G data connection. Additionally, the RAN can determine that any primary data connection is to be terminated or suspended and that data transmissions are to be sent and received via a secondary data connection associated with the user device. Further, the RAN can determine that the type of data connection utilized for data transmissions of the user device is to be modified based on a determination that multiple thresholds of the series of thresholds are satisfied by the device metric. In at least one embodiment, the RAN can cause the user device to fallback to 4G service (i.e., LTE) via the 4G data connection.

At block 408, the RAN can modify the one or more data connections according to the modification determined at block 406. In some embodiments, the modification can be applied in a manner described with respect to blocks 210 and 312.

At block 410, the RAN can continue to monitor the user device and the one or more data connections. In some embodiments, the RAN can monitor the one or more data connections in a manner described with respects to blocks 212 and 314. In some additional embodiments, the RAN can be associated with the plurality of layers of the data connection. Additionally, the RAN can cause the user device to generate individual user device reports for each of the plurality of layers or cause the user device report to include operating values associated with each of the plurality of layers. In some further embodiments, the RAN can continue to receive user device reports received from the user device despite the data connection being suspended. Alternatively, the RAN can receive an indication from the network that the data connection is to be resumed and receive user device reports from the user device monitoring the one or more data connections.

In some embodiments, the above techniques discussed with respect to FIGS. 2, 3, and 4 can be implemented by a user device. Similar to the RAN implemented techniques discussed at blocks 204 and 304, the user device can determine one or more device metrics. For example, the user device can determine a device temperature, a device power consumption, one or more processor speeds, and/or one or more other operating variables associated with the user device. Additionally, the user device can determine a connection metric associated with a data connection of the user device. The connection metric can include an indication of channel quality, an indication of connection utilization, and/or other indications of a current status of the data connection associated with the user device. In some additional embodiments, the user device can determine whether a threshold is satisfied by the one or more device metrics and/or the connection metric associated with the user device and the data connection. For example, the user device can determine whether the threshold is satisfied in a manner described with respect to blocks 206 and 306. Additionally, the user device can determine the threshold, receive the threshold from the RAN, or receive the threshold from the network.

In some embodiments, the user device can determine a coding scheme associated with the data connection. Similar to the RAN implemented techniques discussed at blocks 208 and 310, the user device can determine a coding scheme associated with the data connection and additionally determine a modification for the coding scheme or an additional coding scheme to replace the coding scheme based on the one or more device metrics and/or the connection metric. In at least one embodiment, the user device can determine that the one or more device metrics satisfy the threshold and determine that the coding scheme is to be modified. Additionally, the user device can request the modification for the coding scheme or the additional coding scheme from the RAN and/or the network. Alternatively, the user device can determine the modification for the coding scheme or the additional coding scheme to replace the coding scheme independent from the RAN and the network. Further, the user device can identify the modification for the coding scheme or the additional coding scheme to replace the coding scheme based on one or more compatible coding schemes associated with the user device and/or determined based on a database associated with the RAN and/or the network. In at least one additional embodiment, the user device can determine that the connection metric satisfies the threshold and determine that the coding scheme is to be modified. Similar to the techniques described above, the user device can request or determine the modification for the coding scheme or the additional coding scheme to replace the coding scheme based on the connection metric. Additionally, the user device can determine whether implementing the modification to the coding scheme or replacing the coding scheme will cause the one or more device metrics to satisfy an additional threshold. Accordingly, the user device can determine one or more potential coding schemes based on the connection metric and select the additional coding scheme or the modification based on whether the addition coding scheme/the modification will cause the one or more device metrics to exceed the additional threshold. Further, the user device can determine a predicted effect of each of the one or more potential coding schemes and select the additional coding scheme or the modification based on one or more predicted device metrics and a predicted connection metric associated with each potential coding scheme.

In some embodiments, the user device can apply the modification or the additional coding scheme to the data connection in a manner described with respect to block 210 and 312. Additionally, the user device can cause the modification or the additional coding scheme to be applied to the data connection. For example, the user device can send a request, or modify a user device report to include the request, to the RAN and cause the RAN to apply the modification or the additional coding scheme to the data connection. Further, the user device can apply the modification or the additional coding scheme to one or more data transmissions associated with the data connection and cause the RAN to utilize the modification to the coding scheme or the additional coding scheme. In some additional embodiments, the user device can monitor the one or more device metrics and/or the connection metric after the modification or the additional coding scheme have been applied to the data connection.

In some embodiments, the above techniques described by blocks 404-410 can be performed by the user device. In particular, the techniques described with respect to blocks 404-410 can be performed in a manner described by the respective blocks and/or in a manner described above. Additionally, the user device can iteratively determine whether the one or more device metrics and/or the connection metric satisfy the threshold and update the data connection in response to determining that the threshold is satisfied.

In some embodiments, the techniques described with respect to FIGS. 2, 3, and 4 can be implemented by the RAN without receiving the user device report. In particular, the RAN can determine the one or more device metrics and/or the connection metric based on one or more data transmissions associated with the data connection. Additionally, the RAN can determine the one or more device metrics and/or the connection metric based on a data transmission rate associated with the data connection. Further, the RAN can determine the one or more device metrics and/or the connection metric based on historical data associated with the data connection and/or the user device. Alternatively, the RAN can determine the one or more device metrics and/or the connection metric based on supplemental information associated with the data connection and/or the user device stored or calculated by the RAN, the network, and/or a database associated with the RAN and/or the network. Accordingly, the RAN can determine the one or more device metrics and/or the connection metric without receiving the user device report associated and implement the techniques described with respect to FIGS. 2, 3, and 4.

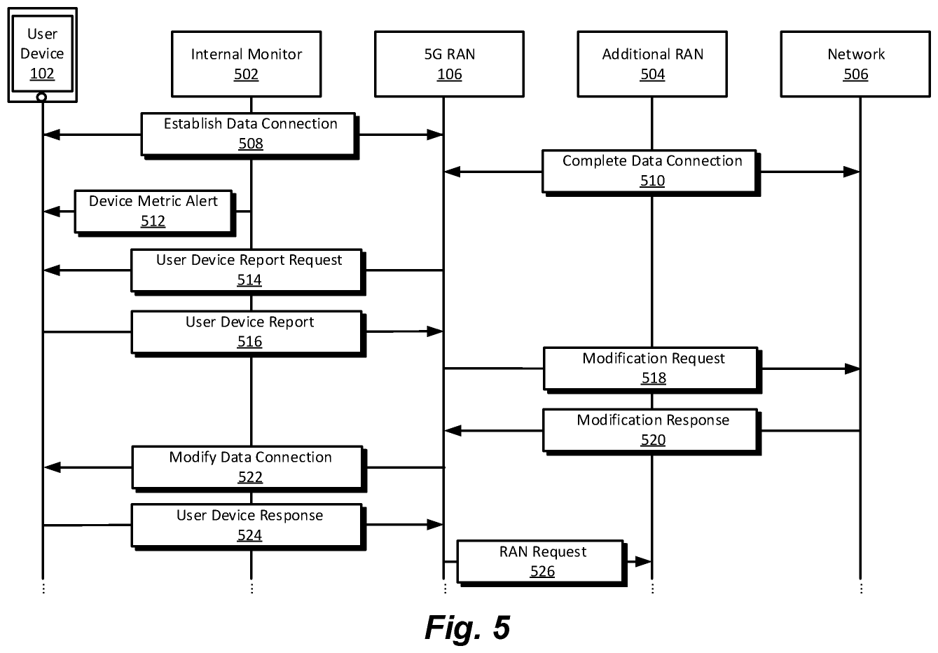

FIG. 5 illustrates a timing diagram for modifying a data connection between a user device 102 and a radio access network (RAN) 106 of the present disclosure. Additional RAN 504 can be any other RAN that is associated with a network 506 and/or the user device 102. The additional RAN 504 can be a second 5G RAN, a 4G RAN, or a RAN that interacts with other network infrastructures. Additionally, the network 506 can be comprised of a 4G user side packet core, a 5G user side packet core, an IMS core, one or more databases, and one or more network resources. Further, any of the above items from FIG. 5 can represent various RANs, network nodes, and resources described in FIGS. 1, 2, 3, and 4.

At 508, the user device 102 and the 5G RAN 106 can establish a data connection for transmitting user device data between the user device 102 and the network 506. In some embodiments, the 5G RAN 106 and the user device 102 can establish a coding scheme associated with the data connection. In at least one embodiment, the coding scheme can comprise a MCS, a TTI, and/or a TB size. In some additional embodiments, the data connection can comprise one or more layers configured to transmit the user device data. In some further embodiments, the data connection can comprise a reporting protocol configured to determine what data connection information is transmitted between the 5G RAN 106 and the user device 102 and what basis the data connection information is transmitted on. In at least one embodiment, the data connection information can be transmitted via a CQI report, a PMI report, and/or a RI report. In at least one additional embodiment, the data connection information sent to the user device 102 can include a threshold that, when satisfied, causes one or more device metrics to be reported, by the user device 102, to the 5G RAN 106. In at least one further embodiment, the data connection information can be transmitted from the 5G RAN 106 to the user device 102 and comprise TPC commands and/or a data connection modification.

At 510, the 5G RAN 106 can complete the data connection and connect the user device 102 with the network 506.

Optionally, at 512, the user device 102 can comprise an internal monitor 502 configured to determine that a user device threshold or a RAN threshold is satisfied by the one or more device metrics. In some embodiments, the internal monitor 502 can be configured to modify the data connection information that is to be sent to the 5G RAN 106. In some additional embodiments, the internal monitor 502 can store the user device threshold associated with a value of the one or more device metrics that should not be met. Alternatively, the internal monitor 502 can store the RAN threshold, transmitted to the user device 102 and determined by the 5G RAN 106, similarly associated with a value of the one or more device metrics. Additionally, the RAN threshold can be associated with a connection metric associated with the data connection.

Optionally, at 514, the 5G RAN 106 can request a user device report. The request can indicate that the user device report is to be transmitted periodically or aperiodically. Additionally, the request can indicate the one or more device metrics to be included in the user device report. In some embodiments, the request can indicate that the user device report is to be repeatedly updated and transmitted to the 5G RAN 106 for a timeframe (e.g., minutes, seconds, hours, milliseconds) or for a number of network frames. In some additional embodiments, the request can indicate that the user device report is to be updated and transmitted to the 5G RAN 106 in response to an event, wherein the event can be the satisfaction of the threshold, the threshold remaining satisfied for the timeframe, and/or an additional threshold in a series of thresholds has been satisfied.

At 516, the user device 102 can transmit the user device report to the 5G RAN 106. In some embodiments, blocks 202-206, 302-306, 402, and 404 describe the various examples of the user device report and the information that comprises the user device reports.

Optionally, at 518 and 520, the 5G RAN 106 can transmit a modification request to the network 506 and receive a modification response from the network 506. In some embodiments, the modification request and response are transmitted to a database that includes information regarding potential modifications for the coding scheme and/or potential alternative coding schemes for the data connection. In at least one embodiment, the 5G RAN 106 can, based on the database, associate one or more potential coding schemes with the user device 102 and determine whether the one or more potential coding scheme are compatible with the user device 102. In at least one additional embodiment, the database can comprise anticipated or historic user device responses associated with the modification or replacement of the coding scheme and the one or more device metrics. In some additional embodiments, the modification request and response include the user device report and an additional request for the network 506 to determine a modification for the coding scheme or to implement throttling for the data connection. In at least one embodiment, the network 506 includes one or more network nodes configured to implement the methods described by FIGS. 1, 2, 3, and 4 with respect to a RAN. In at least one additional embodiment, the network 506 can reduce the amount of data transmitted to the user device 102 in response to the modification request specifying that the data connection between the user device 102 and the network 506 is to be throttled. Additionally, the modification request can specify a percentage that the data connection should be throttled and/or a duration for the data connection to be throttled over.

At 522, the 5G RAN 106 can modify the data connection. In some embodiments, the 5G RAN 106 can modify the data connection in a manner described with respect to blocks 210, 312, and 408.

At 524, the user device 102 can respond to the modification applied to the data connection by the 5G RAN 106. In some embodiments, the user device 102 can respond to the 5G RAN 106 modifying the data connection due to the 5G RAN 106 monitoring the user device 102 and the data connection in a manner described with respect to blocks 212, 314, and 410. In some addition embodiments, the user device 102 can respond to the 5G RAN 106 based on one or more additional thresholds that are satisfied by updated device metrics and/or updated connection metrics caused by the modification of the data connection. Additionally, the user device 102 can report to the 5G RAN 106 one or more resolved thresholds that are no longer satisfied by the updated device metrics and/or the updated connection metrics. In at least one embodiment, the user device response comprises one or more user device reports.

Optionally, at 526, the 5G RAN 106 can transmit a RAN request to the network 506 that is received by an additional RAN 504 associated with the network 506. In some embodiments, the RAN request can cause the additional RAN 504 to become a primary RAN for the user device. Additionally, the data connection associated with the RAN 106 can be suspended, terminated, or assigned to be a secondary data connection. Further, the additional RAN 504 can continue the methods and/or operations described above with respect to FIGS. 1, 2, 3, and 4 after establishing an additional data connection with the user device 102 or assigning an associated data connection to be a primary data connection for the user device. For example, the additional RAN 504 can be a 4G RAN that becomes the primary RAN in response to the 5G RAN 106 determining that previous data connection modifications have not resolved an ongoing issue associated with the user device 102. Alternatively, the additional RAN 504 can be a second 5G RAN that is configured to resolve the ongoing issue associated with the user device 102 or the data connection. In some additional embodiments, the RAN request can cause the additional RAN 504 to create, resume, suspend, or termination one or more additional layers associated with the user device 102. In particular, the user device 102 can be configured to operate in a multiple input multiple output (MIMO) framework. Accordingly, the 5G RAN 106 can cause the additional RAN 504 to modify a number of layers transmitting data to and from the user device 102 and modulating the volume of data that is transmitted for the user device 102.

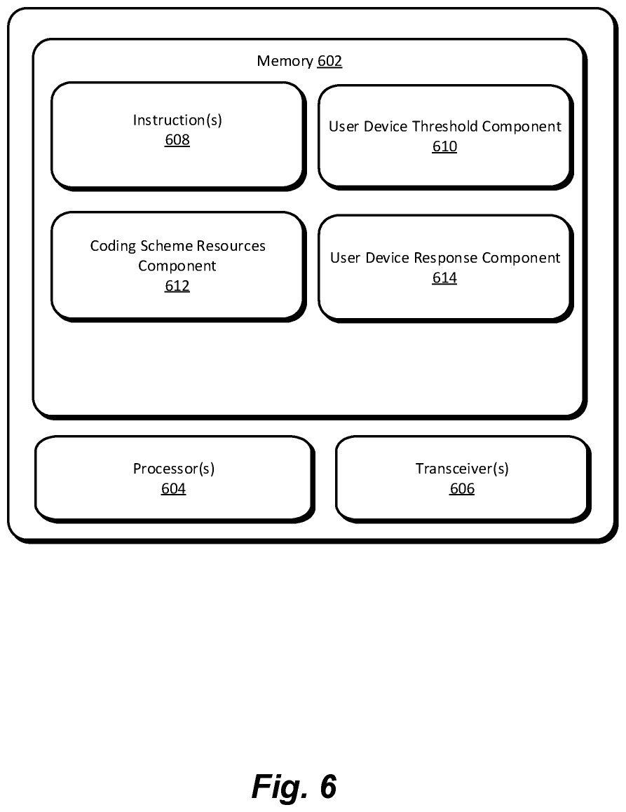

FIG. 6 illustrates a block diagram of a Radio Access Network (RAN) capable of implementing the methods disclosed herein, in accordance with some examples of the present disclosure. In some embodiments, the RAN can correspond to any of the RANs discussed with respect to FIGS. 1, 2, 3, 4, and 5. As illustrated, the RAN is generally comprised of memory 602, one or more processors 604, and one or more transceivers 606.

In some embodiments, the memory 602 can be volatile (such as RAM), non-volatile (such as ROM, flash memory, etc.) or some combination of the two. The memory 602 can include removable storage, non-removable storage, and other forms of computer-readable media including, but not limited to RAM, ROM, EEPROM, flash memory, other memory technologies, CD-ROM, DVDs, content-addressable memory (CAM), other optical storage, magnet storage, and any other medium which can be used to store the desired information in a format that can be accessed by the RAN. The memory 602 can comprise one or more instructions 608 that are executed by the one or more processors 604 and cause the one or more processors 604 to perform operations of the methods discussed above. Further, the memory 602 can comprise additional components that can be executed by the one or more processors 604 and cause the one or more processors 604 to perform additional operations associated with the RAN. The additional components can comprise network forwarding components, network monitoring components, and other network components.

In some embodiments, the one or more processors 604 can include one or more central processing units (CPUs), one or more graphics processing units (GPUs), both CPUs and GPUs, or other processing units or components known in the art.

In some embodiments, the one or more transceivers 606 can include one or more wired or wireless transceivers. For example, the one or more transceivers 606 can include a network interface card, a network adapter, a LAN adapter, an address associated with a network connection, or another device permitting communications to be sent and received. Additionally, the one or more transceivers 606 can comprise any wireless transceiver capable of engaging in wireless, radio frequency (RF) and/or millimeter wave (mmW) communication. Further, the one or more transceivers 606 can also include other wireless modems, such as Wi-Fi, WiMax, Bluetooth, and/or infrared communication modems.

In some embodiments, the one or more instructions 608 can cause the one or more processors 604 and the one or more transceivers 606 to perform operations that comprise the methods discussed above. These operations can include, but are not limited to, receiving a user device report from a user device associated with a network, identifying one or more device metrics and/or connection metrics associated with the user device and/or the data connection, determining whether the one or more device metrics and/or connection metrics satisfy one or more thresholds, determining a modification to be applied to the data connection, monitoring an effect the modification causes with respect to the one or more device metrics and/or connection metrics, determining whether the one or more thresholds remain satisfied by the one or more device metrics and/or connection metrics, and iterating through the above operations until the one or more thresholds are no longer satisfied by the user device and/or the data connection. In some additional embodiments, the one or more instructions 608 further utilize a user device threshold component 610 for determining and maintaining the one or more thresholds, a coding scheme resource component 612 for identifying coding schemes and coding scheme modifications to be applied to the data connection, and a user device response component 614 for determining whether a particular coding scheme or coding scheme modification should be applied to the data connection.

In some embodiments, the user device threshold component 610 can comprise one or more thresholds associated with the one or more device metrics and the one or more connection metrics of the data connection between the RAN and the user device. In some additional embodiments, the user device threshold component 610 includes specifications associated with the user device and is configured to determine the one or more thresholds. In some further embodiments, the user device threshold component 610 includes one or more user indications and/or network indications that define the one or more thresholds associated with the data connection.

In some embodiments, the coding scheme resource component 612 can comprise one or more compatible coding schemes associated with the RAN. In some additional embodiments, the coding scheme resource component 612 further comprises variations and value ranges associated with the one or more compatible coding schemes. In some further embodiments, the coding scheme resource component 612 further comprises the compatibility of one or more user devices associated with each of the one or more compatible coding schemes.

In some embodiments, a user device response component 614 can comprise one or more user device responses to implemented coding scheme modifications. In some additional embodiments, the user device response component 614 can track a device status for each of the one or more user devices and record the device status over time. Additionally, the user device response component 614 can store historical data for each of the one or more user devices. Further, the coding scheme resource component 612 can utilize the historical data when identifying coding scheme modifications to be applied to the data connection. In some further embodiments, the user device response component 614 can be configured to model predicted responses for each of the one or more user devices to determine whether the coding scheme modification should be implemented for the data connection.

In some embodiments, additional network resources can be stored by the memory 602 and can comprise a listing of other network nodes, servers associated with the network, or network resources that may be consulted during the operations caused by the instructions 608.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving, from a user device, a user device report;
determining, based at least on the user device report, that a user device temperature exceeds a temperature threshold;
identifying a data connection associated with the user device that transmits user data according to a first coding scheme;
determining, based at least on the temperature threshold being satisfied, a second coding scheme to reduce the user device temperature below the temperature threshold; and
modifying the data connection to transmit the user data according to the second coding scheme.

2. The method of claim 1, wherein the user device report comprises at least one of:
a Channel Quality Indicator (CQI);
a Precoding Matrix Indicator (PMI); or
a Rank Indicator (RI).

3. The method of claim 1, wherein the first coding scheme or the second coding scheme indicates at least one of:
a Modulation and Coding Scheme (MC S);
a Time Transmission Interval (TTI);
a Transport Block Size (TB size);
a receive window for the user device; or
an operating power for the user device.

4. The method of claim 1, wherein:
the first coding scheme causes the user device to receive the user data at a first rate; and
the second coding scheme causes the user device to receive the user data at a second rate less than the first rate, the second rate determined to reduce the user device temperature.

5. The method of claim 1, further comprising:
receiving, from the user device operating under the second coding scheme, an additional user device report;
determining, based at least on the additional user device report, that the user device temperature exceeds the temperature threshold; and
modifying the data connection to reduce a number of connections maintained by the user device.

6. A system comprising:
one or more processors; and
a memory that includes one or more computer-executable instructions that cause the one or more processors to perform operations comprising:
receiving, from a user device, a first user device report;
determining, based at least on the first user device report, whether a threshold is satisfied by the user device;
identifying a data connection associated with the user device;
determining, based at least on the first user device report and the threshold, a coding scheme configured to regulate a data transmission rate associated with the data connection; and
monitoring, via one or more second user device reports, a user device state to determine whether the threshold is satisfied by the user device.

7. The system of claim 6, wherein:
the first user device report is a periodic user device report that is transmitted by the user device; and
the first user device report is received from the user device after a timeframe has expired, the timeframe starting when a previous user device report is received from the user device.

8. The system of claim 6, wherein the first user device report is an aperiodic user device report that is transmitted by the user device in response to an event associated with the user device.

9. The system of claim 8, wherein:
the event is a first user device report request that is transmitted to the user device and causes the user device to generate the aperiodic user device report; and
the first user device report request specifies one or more device metrics, associated with the user device, that are associated with the threshold and are received via the first user device report.

10. The system of claim 6, wherein determining the coding scheme further comprises:
identifying one or more potential coding schemes;
determining, based at least in part on the first user device report, one or more device metrics associated with the user device;
identifying, based at least on the threshold, a device metric that satisfies the threshold; and
determining, based at least in part on the device metric, the coding scheme configured to regulate the data transmission rate and reduce the device metric below the threshold.

11. The system of claim 6, wherein monitoring the user device state further comprises:
receiving, from the user device and via the data connection, a second user device report;
determining, based at least on the second user device report, that the user device satisfies the threshold; and
determining, based at least on the second user device report and the threshold, a second coding scheme configured to regulate the data transmission rate associated with the data connection.

12. The system of claim 6, wherein monitoring the user device state further comprises:
determining an additional threshold associated with the threshold and the user device;
determining, based at least on the first user device report, that the user device satisfies the threshold and the additional threshold;
identifying, based at least on the user device satisfying the additional threshold, an additional data connection; and
causing the user device to utilize the additional data connection and suspend transmissions via the data connection.

13. A method comprising:
receiving, from a user device, a user device report indicating a connection condition associated with a data connection of the user device;
identifying, based at least on the user device report, a user device state and a first coding scheme associated with the data connection;
determining, based at least on the connection condition, a second coding scheme to be applied to the data connection; and
modifying, based at least on the user device state, the second coding scheme to prevent the user device from satisfying a threshold.

14. The method of claim 13, wherein determining the second coding scheme further comprises:
determining the second coding scheme based at least in part on the connection condition and the user device state, the user device state including at least a device metric; and
determining, based at least in part on the device metric, that the second coding scheme will not cause the user device state to satisfy a threshold associated with the user device.

15. The method of claim 13, further comprising:
determining, based at least in part on the connection condition, that a bandwidth of the data connection is less than a data threshold associated with the first coding scheme; and
applying, based on the connection condition, the second coding scheme configured to modify the one or more data transmissions and cause the bandwidth to exceed the data threshold.

16. The method of claim 15, wherein:
determining that the bandwidth of the data connection is less than the data threshold comprises determining a first data transmission rate associated with the data connection is less than an optimal data transmission rate; and
applying the second coding scheme modifies the data connection and causes the one or more data transmissions to be sent at the optimal data transmission rate.

17. The method of claim 13, further comprising:
monitoring, based at least in part on applying the second coding scheme to the data connection, the connection condition and the user device state;
receiving, from the user device, an additional user device report;
determining, based at least in part on the additional user device report, an updated user device state; and
determining, based at least in part on the connection condition and the updated user device state, a third coding scheme to be applied to the data connection.

18. The method of claim 17, wherein:
the first coding scheme causes the user device to receive user data at a first rate; and
the second coding scheme causes the user device to receive the user data at a second rate greater than the first rate.

19. The method of claim 18, wherein:
the third coding scheme causes the user device to receive the user data at a third rate greater than the second rate; and
determining the third coding scheme is further based at least on the updated user device state not satisfying a threshold associated with the user device.

20. The method of claim 18, wherein:
the third coding scheme causes the user device to receive the user data at a third rate less than the second rate and greater than the first rate; and
determining the third coding scheme is further based at least on the updated user device state satisfying a threshold associated with the user device.
